(19) United States
(12) Patent Application Publication
(10) Pub. No.: US 2017/0068822 A1
(43) Pub. Date: Mar. 9, 2017

(54) Method for binding a software application's functionality to specific storage media

(71) Applicant: Daniel Cave, Louisville, TN (US)

(72) Inventor: Daniel Cave, Louisville, TN (US)

(73) Assignee: BIT SPHERE INC., Maryille, TN (US)

(21) Appl. No.: 14/844,173

(22) Filed: Sep. 3, 2015

(51) Int. Cl. G06F 21/62; G06F 21/12

(52) U.S. Cl. CPC G06F 21/629; G06F 21/121; G06F 21/12; G06F 2221/0773; G06F 2221/0704

(57) ABSTRACT

A proposed method for binding the functionality of a software application to the specific storage media that the software application is stored on and executed from. Furthermore, this method will prevent copies of the software application from being fully-executable and/or allowing for the execution of alternate processes, or the suppression of alternate processes when the software application is not stored on and executed from the storage media that the software application is bound to by this method.

### FIELD OF THE INVENTION

The present invention relates to a Digital Rights Management (DRM) method to protect and/or monitor copyrights on computer software that is distributed on physical storage media.

### BACKGROUND AND PRIOR ART

Copyrighted computer software has long been distributed on physical storage media, including but not limited to magnetic disks, optical discs, and non-volatile memory devices. There has long been a need to prevent unlicensed copies of copyrighted computer software from being used without the consent of the copyright holders. Such unlicensed copies often mean lost revenue on a product that was costly to develop. Many methods have been devised to try solve this problem by attempting to prevent copies of the digital content from being created. Many of those methods are file system or computer operating system dependent and can easily be defeated by accessing the files with a different operating system other than the one the file was protected with, or by modifying the file system the file is stored on. Other attempts to protect computer software distributed on physical storage media include the use of passwords or some other sequence of characters which have to be entered in some fashion, to use the copyrighted software. In recent times this method has proven to be of little value since the correct passwords or character sequences are either distributed with the copies of the data or they are easily obtainable by keyword searches on Internet search engines. Another widely used method of protecting copyrighted computer software is to encrypt the software files through the use of industry standard encryption algorithms or in some instances, proprietary encryption algorithms. These methods require a decryption key or some other method of decrypting the files before the files can be used. This method has many of the same shortcomings that using passwords to protect software files have. Decryption keys and decryption methods are either distributed with the unlicensed copies or are easily obtainable. Also with the increase of easily affordable processing power, many passwords or decryption keys can be discovered by way of brute-force or dictionary attacks on the protected software files.

### SUMMARY

This invention seeks to protect the digital rights of computer software distributed on physical storage media. This invention includes a method for binding licensed copies of computer software to the specific storage media that the licensed copies are stored on and executed from. Furthermore the method of this invention provides a way to determine if the computer software is on the specific storage media that the computer software was originally distributed on. The method will allow the software application to reach a fully functional state if it is executed from the correct storage media. Conversely, the method of the current invention can terminate the software application and/or execute alternate processes if the software application isn't executed from the correct storage media.

### BRIEF DESCRIPTION OF THE DRAWINGS

FIG. 1 is a block diagram of a general computer system which pertains to one or more embodiments herein.

FIG. 2 is a flowchart of one embodiment of the current invention.

FIG. 3 is a flowchart of an alternate embodiment of the current invention.

FIG. 4 is a flowchart of an alternate embodiment of the current invention.

FIG. 5 is a flowchart of one comparison procedure used by the embodiments of the current invention.

FIG. 6 is a flowchart of an alternate comparison procedure used by the embodiments of the current invention.

FIG. 7 is a flowchart of an alternate comparison procedure used by the embodiments of the current invention.

### DETAILED DESCRIPTION OF THE INVENTION

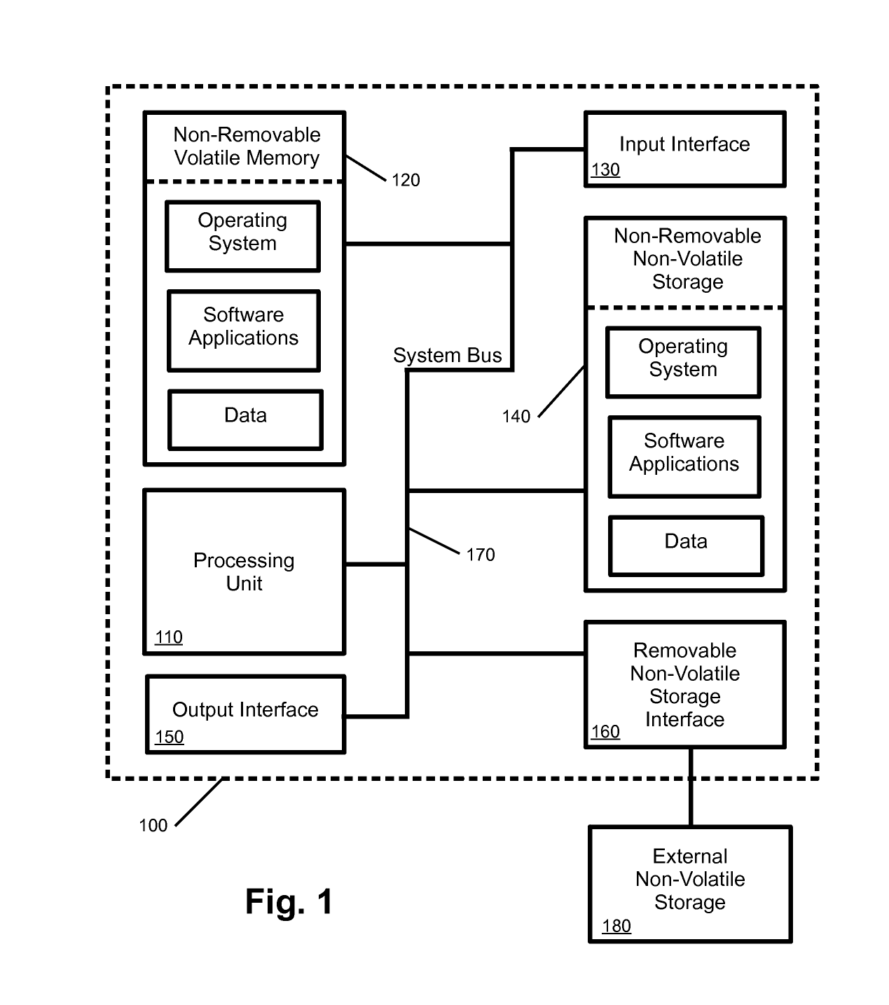

Embodiments of the current invention are computer-executable instructions that would be run on a computer device similar in form to the computer device 100 of FIG. 1. Components of computer device 100 may include, but aren't limited to, a processing unit 110, Non-removable volatile memory 120 (also referred to as system memory), an input interface 130, Non-removable non-volatile storage 140 (e.g., an internal hard disk drive, internal solid-state drive, etc.), an output interface 150, a removable non-volatile storage interface 160 for connecting external non-volatile storage 180 (e.g., an external hard disk drive, flash drive, cd-rom, dvd-rom, etc.), and a system bus 170 that connects various components together. It is important to note that while FIG. 1 shows a block diagram of a simplified computer device suitable for the current invention, FIG. 1 is not meant to limit the scope of any claims of the current invention. It should be evident to those of ordinary skill in the art, that computer devices that run computer-executable instructions (also referred to as software applications), can take on many different forms.

Herein, computer-executable instructions that individually or together can perform computer tasks will be referred to as a software application. The term software application is well known by those of ordinary skill in the art and doesn't need detailed explanation here. Furthermore the term software application does not limit its' self to one application but can refer to a plurality of software applications.

The software application will be executed on a computer device 100 typical of the one shown in FIG. 1. The software application can be stored on either non-removable, non-volatile storage media 140 or it can be on removable, non-volatile storage media 180. Removable storage is often referred to as external storage.

For the purpose of the current invention, storage media can refer to not only media capable of the physical storage of the data bits but also devices that as a unit are capable of functioning as storage media even though they contain as a unit more components than the component that physically stores the data bits. Examples of such devices include but aren't limited to hard disk drives, and flash drives.

For the purpose of current invention, external or removable non-volatile storage 180 pertains to any storage media that can retain its data if not connected to a power source and/or disconnected from the computer device 100.

For the purpose of the current invention, storage media identification will refer to any information used by the computer device 100 to identify the storage media for use by the computer device 100. Storage media identification can also refer to characteristics of the storage media such as but not limited to type of media or the capacity of the media. Storage media identification may also refer to any data accessible by the computer device 100 related to the storage media which is accessible in some form on the storage media. The storage media identification may contain bits of data combined from multiple data sources which describe the storage media. The storage media identification will be considered to be in a non-obfuscated state if the storage media identification is in the form that is used by the computer device to identify the storage media.

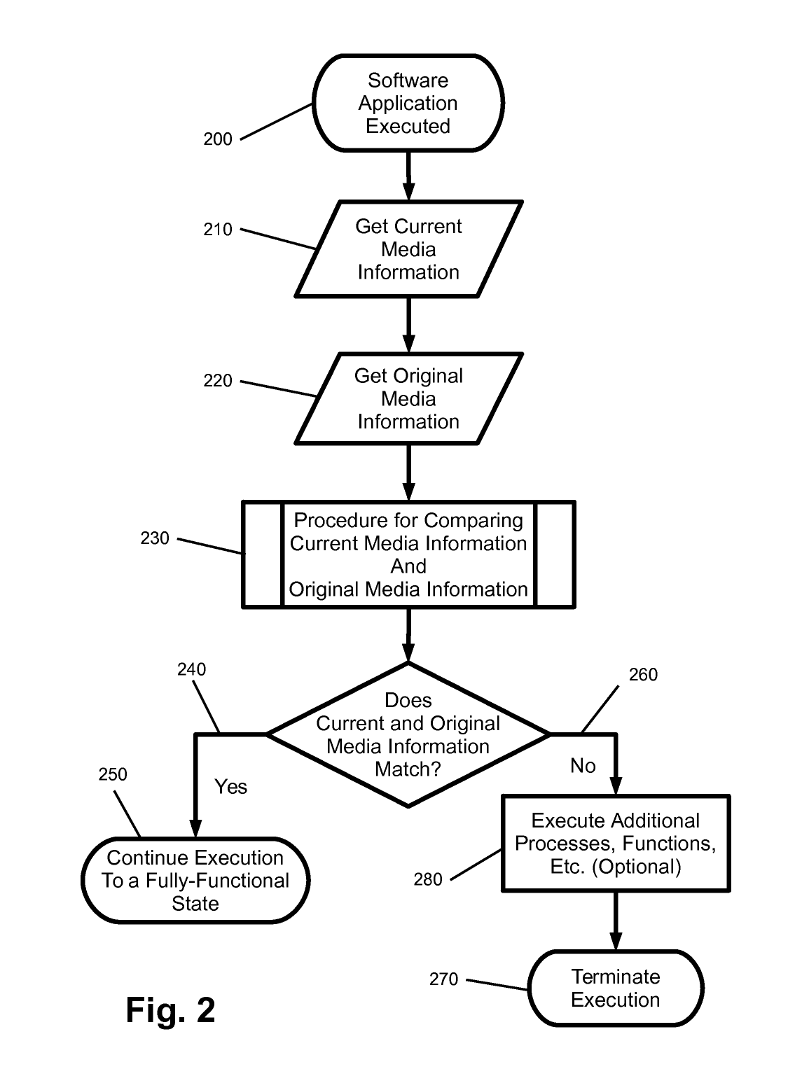

The preferred embodiments of the current invention provide a way to bind a software application to a specific storage media or to determine how much functionality the software application has if the software application is not stored or executed on the proper storage media. The method of the current invention is implemented by comparing storage media identification of the media that the software application is stored on or executed from with the storage media identification that describes storage media that allows for the software application to reach a fully-functional state. Fully-functional state can have various different meanings depending on the context. Herein the term ‘fully-functional state’ can mean, in addition to common meanings, the ultimately desired state of the software application as anticipated by the owner of the software license. While the spirit of the invention can be embodied in many ways, this preferred embodiment is described as follows and as shown in FIG. 2.

Upon the initial execution of the software application 200, the software application will query the computer device or the storage media, for the storage media identification of the storage media that the software application is being executed from 210. We will call this storage media information the Current Storage Media Identification 210. The software application will then retrieve by some manner a value or set of values that represent the storage media identification that the software application is bound to 220. We will call this storage media information the Original Storage Media Identification 220. The software application can access the Original Storage Media Identification in many ways, including but not limited to, querying a server for the information, reading the information from a database, reading the information from a file or a plurality of files, or obtaining the information from any public or private data store accessible by the software application. It is unimportant to the current invention as to whether the Current Storage Media Information is obtained before, after, or at the same time as the Original Storage Media Information.

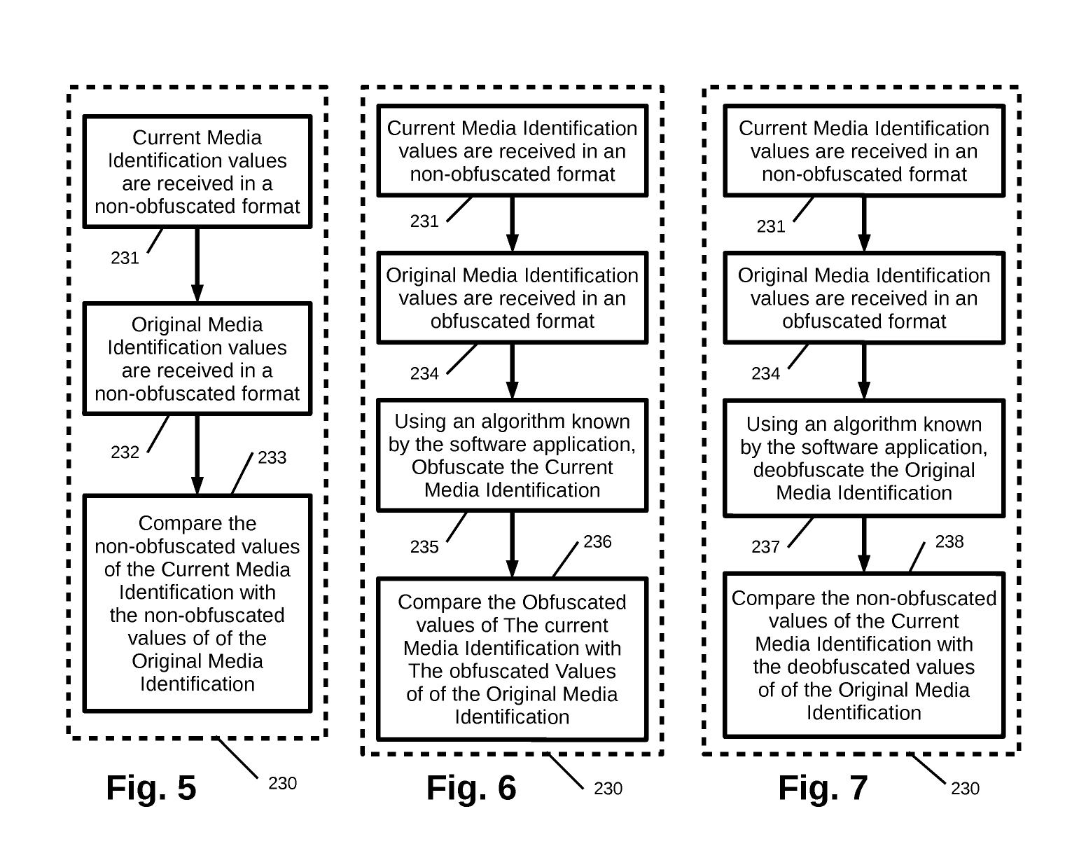

The software application will then use a comparison procedure 230 to compare the Current Storage Media Identification with the Original Storage Media Identification. The comparison procedure can take on several different forms depending upon whether or not the Original Storage Media Identification is obfuscated. FIG. 5 shows one embodiment of the the comparison procedure which can be used if the Original Storage Media Identification is not obfuscated. The procedure 230 receives the Current Storage Media Identification 231 values from some storage of the data in the software application, after the software application has acquired that information 210. Since this information is originally being received directly from the computer device or the storage media it will most likely not be obfuscated. Then the procedure 230 received the Original Storage Media Identification 232 values in a non-obfuscated form from some storage of the data in the software application, after the software application has acquired that information 220. It is unimportant to procedure 230 as to whether the Current Storage Media Information 231 is received before, after, or at the same time as the Original Storage Media Information 232. The comparison procedure 230 will compare the non-obfuscated Current Storage Media Information 231 with the non-obfuscate Original Storage Media Information 232 by any means well known in the art of software applications.

Referring back to FIG. 2, if the comparison procedure 230 determines that the Current Storage Media Information values and the Original Storage Media Information values match 240, then the software application can continue execution and become fully functional 250. If the values don't match 260, then the software application may cease execution 270. Optionally at this point, before the software application is terminated, the software application may execute one or more additional processes, functions, or software applications that can perform additional computer tasks 280. These would be computer tasks that the software may not normally execute if the Current Storage Media identification 210 and the Original Storage Media identification 220 matched, such as but not limited to, displaying a message, sending information about the non-matching media identification to a server, showing advertisements, and etc. Also, instead of executing one or more additional processes, functions, or software applications, additional processes, functions, or software applications may be suppressed or terminated to prevent the computer device 100 from performing additional computer tasks. These would be processes, functions, or software applications that may not normally be suppressed or terminated if the Current Storage Media Identification 210 and the Original Storage Media Identification 220 matched. Such as but not limited to preventing a message from being displayed, or to prevent blocking of advertisements.

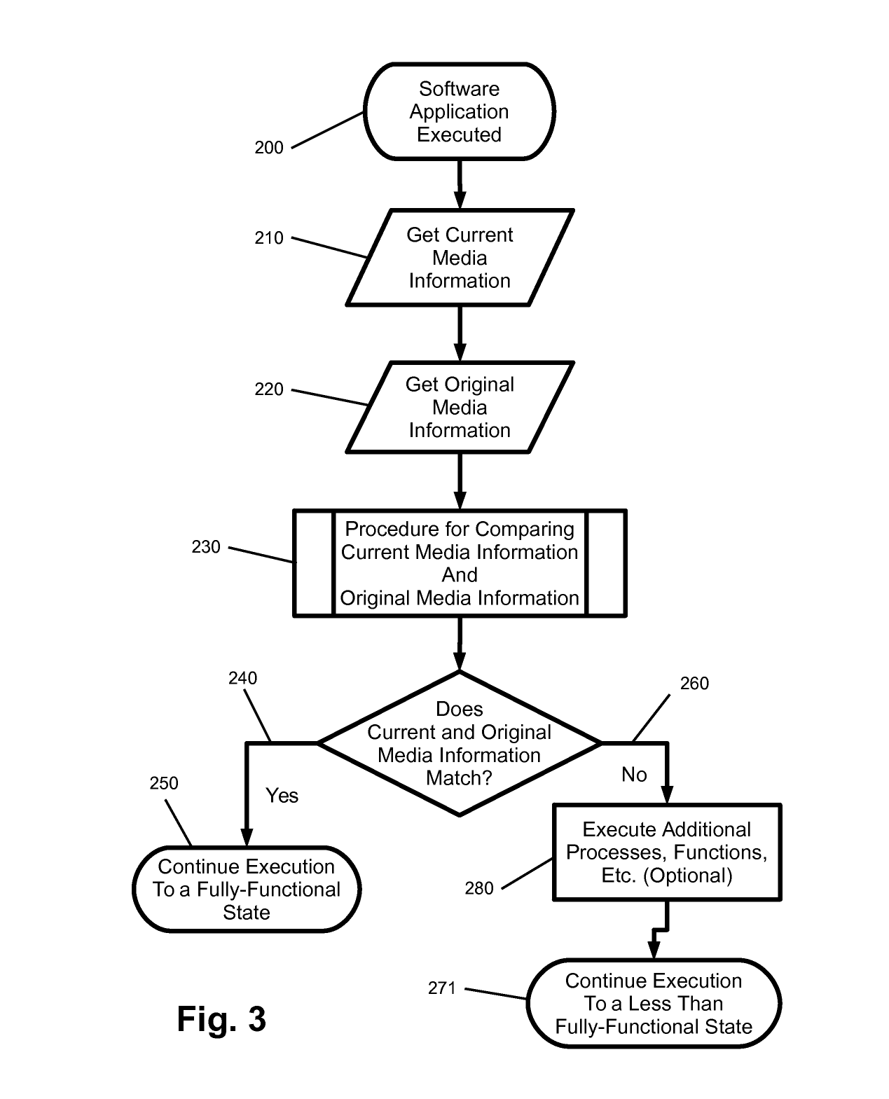

Another embodiment of the current invention is shown in FIG. 3. This embodiment will allow the software application, after being executed 200 to load to a state of limited-functionality 271 if the comparison procedure 230 of the current invention determines that the Current Storage Media Identification 210 and the Original Storage Media Identification 220 don't match 260. Optionally at this point the software may execute one or more additional processes, functions, or software applications that can perform additional computer tasks 280. These would be computer tasks that the software may not normally execute if the Current Storage Media Identification 210 and the Original Storage Media Identification 220 matched. Also, instead of executing one or more additional processes, functions, or software applications, additional processes, functions, or software applications may be suppressed or terminated to prevent the computer device 100 from performing additional computer tasks. These would be processes, functions, or software applications that may not normally be suppressed or terminated if the Current Storage Media Identification 210 and the Original Storage Media Identification 220 matched.

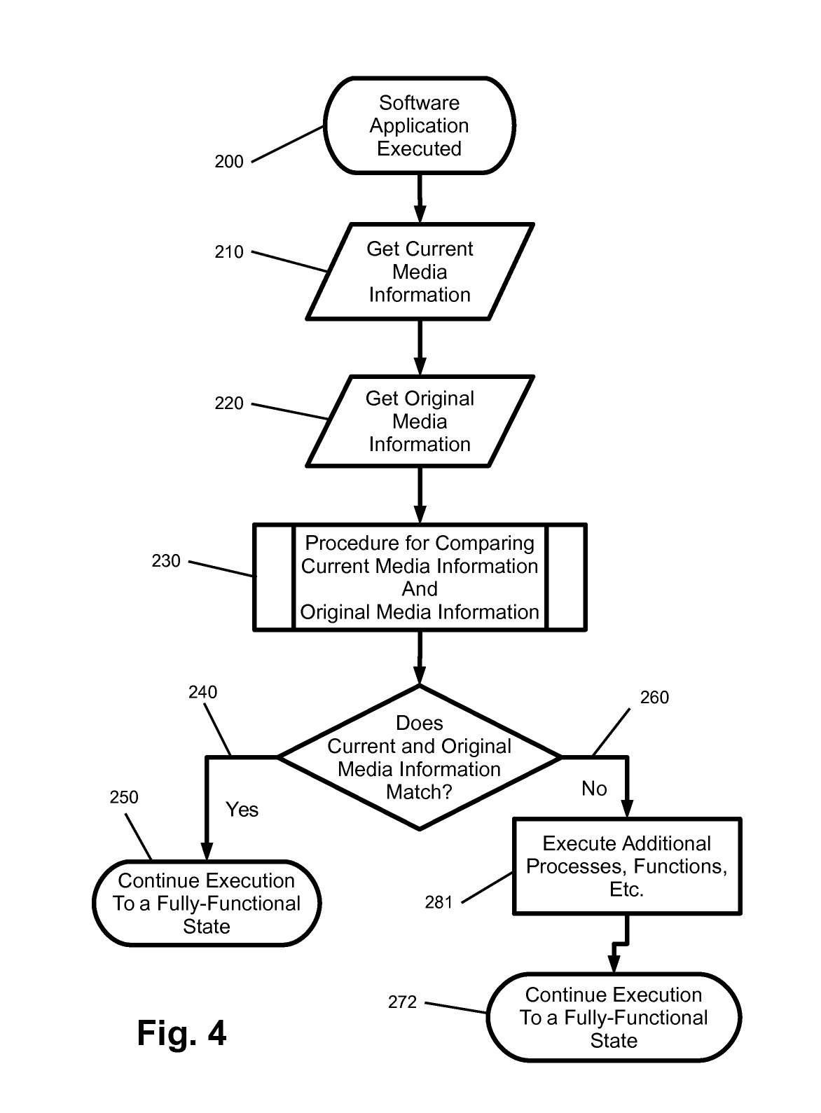

Another embodiment of the current invention is shown in FIG. 4. This embodiment will allow the software application, after being executed 200 to load to a fully functional state 272 if the comparison procedure 230 of the current invention determines that the Current Storage Media Identification 210 and the Original Storage Media Identification 220 don't match 260. At this point the software may execute or suppress one or more additional processes, functions, or software applications that can perform additional computer tasks 281, such as but not limited to, showing advertisements. These would be computer tasks that the software may not normally execute or suppress if the Current Storage Media Identification 210 and the Original Storage Media Identification 220 matched.

To prevent someone from circumventing the method of the current invention, it is advantageous to receive the Original Storage Media Identification information in an obfuscated form. There are many ways with which to obfuscate the information such as but not limited to, encoding, encrypting, and/or splitting and rearranging the data. The specific means by which the Original Storage Media Identification is obfuscated is not primarily important but the algorithm or means by which the data is obfuscated will need to be known by the software application implementing the method of the current invention.

Any embodiment of the current invention that receives the Original Storage Media Identification values in an obfuscated form will require an alternate comparison procedure 230 as shown in FIG. 6 and FIG. 7. In FIG. 6 the comparison procedure 230 receives the Current Storage Media Information in a non-obfuscated form 231. Comparison procedure 230 receives the Original Storage Media Identification in an obfuscated form 234. The comparison procedure 230 then obfuscates the Current Storage Media Information 235 using the same algorithm that was used to obfuscate the Original Storage Media Information before it was received by the comparison procedure 230. Now that both the Current Storage Media Information and the Original Storage Media Information are in an obfuscated form, the comparison procedure can compare obfuscated values to obfuscated values 236 to determine if the two values describe the same storage media.

In FIG. 7 the comparison procedure 230 receives the Current Storage Media Information in a non-obfuscated form 231. Comparison procedure 230 receives the Original Storage Media Identification in an obfuscated form 234. The comparison procedure 230 then deobfuscates the Original Storage Media Identification 237 using the reverse of the algorithm that was used to obfuscate the Original Storage Media Information before it was received by the comparison procedure 230. Now that both the Current Storage Media Information and the Original Storage Media Information are in a non-obfuscated form, the comparison procedure can compare non-obfuscated values to non-obfuscated values 238 to determine if the two values describe the same storage media.

Although it is unlikely, it is possible that the comparison procedure 230 will receive the Current Storage Media Information in an obfuscated format. In that case, embodiments of the current invention will need other alternate comparison procedures that allow for comparing the Current Storage Media Identification values and the Original Storage Media Information values in similar states of obfuscation.

What is claimed is:

1. A computer implemented method to require a software application to be executed from a specific storage media for the software application (or certain features thereof) to reach a fully functional state comprising:
a software application that is stored on some form of storage media suitable for storing digital data and can be executed by a computer device;
said software application once having been executed on a computer device has:
a means by which the software application is in communication with the ‘Current Storage Media Identification’ a term I have created to mean data or values readable by a computer device that can identify in some manner the storage media that the software is being executed from;
a means by which the software application is in communication with the ‘Original Storage Media Identification’ a term I have created to mean data or values that can identify in some manner the storage media that the software is required to be executed from to reach a fully functional state;
a comparison procedure by which the Current Storage Media Identification and the Original Storage Media Identification are compared to determine if the Current Storage Media Identification and the Original Storage Media Identification describe the same storage media or describe different storage media;
said computer implemented method will allow the software application to reach a fully functional state if said comparison procedure determines that the Current Storage Media Identification and the Original Storage Media Identification describe the same storage media;
said computer implemented method will terminate the software application if said comparison procedure determines that the Current Storage Media Identification and the Original Storage Media Identification do not describe the same storage media.

2. The method of claim 1, wherein the Original Storage Media Identification is delivered to said software application in an obfuscated/encoded and/or encrypted form using an algorithm or algorithms known by said software application, and said software application after acquiring the Current Storage Media Identification, obfuscates/encodes and/or encrypts the Current Storage Media Identification using said algorithm so that the stated comparison procedure of claim 1 can compare the Current Storage Media Identification and the Original Storage Media Identification in an obfuscated/encoded and/or encrypted form.

3. The method of claim 1, wherein the Original Storage Media Identification is delivered to said software application in an obfuscated/encoded and/or encrypted form using an algorithm or algorithms known by said software application, and said software application will deobfuscate/decode and/or decrypt the Original Storage Media Identification using said algorithm so that the stated comparison procedure of claim 1 can compare the Current Storage Media Identification and the Original Storage Media Identification in a deobfuscated/decoded and/or decrypted form.

4. The computer implemented method of claim 1, wherein the storage media identification data or values contain, at least in some part, data or values that represent characteristics of the storage media; such as but not limited to storage media capacity, storage media manufacturer, or storage media type.

5. The method of claim 1 wherein if said comparison procedure of claim 1 determines that the Current Storage Media Identification and the Original Storage Media Identification do not describe the same storage media, one or more additional processes, functions or software applications are executed that would not be executed if the Current Storage Media Identification and the Original Storage Media Identification did describe the same storage media.

6. The method of claim 1 wherein if said comparison procedure of claim 1 determines that the Current Storage Media Identification and the Original Storage Media Identification do not describe the same storage media, the execution of one or more additional processes, functions or software applications are suppressed and/or terminated, that would not be suppressed and/or terminated if the Current Storage Media Identification and the Original Storage Media Identification did describe the same storage media.

7. A computer implemented method to require a software application to be executed from a specific storage media for the software application (or certain features thereof) to reach a fully functional state comprising:
a software application that is stored on some form of storage media suitable for storing digital data and can be executed by a computer device;
said software application once having been executed on a computer device has:
a means by which the software application is in communication with the ‘Current Storage Media Identification’ a term I have created to mean data or values readable by a computer device that can identify in some manner the storage media that the software is being executed from;
a means by which the software application is in communication with the ‘Original Storage Media Identification’ a term I have created to mean data or values that can identify in some manner the storage media that the software is required to be executed from to reach a fully functional state;
a comparison procedure by which the Current Storage Media Identification and the Original Storage Media Identification are compared to determine if the Current Storage Media Identification and the Original Storage Media Identification describe the same storage media or describe different storage media;
said computer implemented method will allow the software application to reach a fully functional state if said comparison procedure determines that the Current Storage Media Identification and the Original Storage Media Identification describe the same storage media;
said computer implemented method will cause the software to load to a state of limited functionality if said comparison procedure determines that the Current Storage Media Identification and the Original Storage Media Identification do not describe the same storage media.

8. The method of claim 7, wherein the Original Storage Media Identification is delivered to said software application in an obfuscated/encoded and/or encrypted form using an algorithm or algorithms known by said software application, and said software application after acquiring the Current Storage Media Identification, obfuscates/encodes and/or encrypts the Current Storage Media Identification using said algorithm so that the stated comparison procedure of claim 7 can compare the Current Storage Media Identification and the Original Storage Media Identification in an obfuscated/encoded and/or encrypted form.

9. The method of claim 7, wherein the Original Storage Media Identification is delivered to said software application in an obfuscated/encoded and/or encrypted form using an algorithm or algorithms known by said software application, and said software application will deobfuscate/decode and/or decrypt the Original Storage Media Identification using said algorithm so that the stated comparison procedure of claim 7 can compare the Current Storage Media Identification and the Original Storage Media Identification in a deobfuscated/decoded and/or decrypted form.

10. The computer implemented method of claim 7, wherein the storage media identification data or values contain, at least in some part, data or values that represent characteristics of the storage media; such as but not limited to storage media capacity, storage media manufacturer, or storage media type.

11. The method of claim 7 wherein if said comparison procedure of claim 7 determines that the Current Storage Media Identification and the Original Storage Media Identification do not describe the same storage media, one or more additional processes, functions or software applications are executed that would not be executed if the Current Storage Media Identification and the Original Storage Media Identification did describe the same storage media.

12. The method of claim 7 wherein if said comparison procedure of claim 7 determines that the Current Storage Media Identification and the Original Storage Media Identification do not describe the same storage media, the execution of one or more additional processes, functions or software applications are suppressed and/or terminated, that would not be suppressed and/or terminated if the Current Storage Media Identification and the Original Storage Media Identification did describe the same storage media.

13. A computer implemented method to require a software application to be executed from a specific storage media for the software application (or certain features thereof) to reach a fully functional state comprising:
a software application that is stored on some form of storage media suitable for storing digital data and can be executed by a computer device;
said software application once having been executed on a computer device has:
a means by which the software application is in communication with the ‘Current Storage Media Identification’ a term I have created to mean data or values readable by a computer device that can identify in some manner the storage media that the software is being executed from;
a means by which the software application is in communication with the ‘Original Storage Media Identification’ a term I have created to mean data or values that can identify in some manner the storage media that the software is required to be executed from to reach a fully functional state;
a comparison procedure by which the Current Storage Media Identification and the Original Storage Media Identification are compared to determine if the Current Storage Media Identification and the Original Storage Media Identification describe the same storage media or describe different storage media;
said computer implemented method will allow the software application to reach a fully functional state if said comparison procedure determines that the Current Storage Media Identification and the Original Storage Media Identification describe the same storage media;
If said comparison procedure determines that the Current Storage Media Identification and the Original Storage Media Identification do not describe the same storage media, said computer implemented method will allow the software to load to a fully functional state, and one or more additional processes, functions, or software applications will be executed and/or suppressed that would not be executed and/or suppressed if the Current Storage Media Identification and the Original Storage Media Identification did describe the same storage media.

14. The method of claim 13, wherein the Original Storage Media Identification is delivered to said software application in an obfuscated/encoded and/or encrypted form using an algorithm or algorithms known by said software application, and said software application after acquiring the Current Storage Media Identification, obfuscates/encodes and/or encrypts the Current Storage Media Identification using said algorithm so that the stated comparison procedure of claim 13 can compare the Current Storage Media Identification and the Original Storage Media Identification in an obfuscated/encoded and/or encrypted form.

15. The method of claim 13, wherein the Original Storage Media Identification is delivered to said software application in an obfuscated/encoded and/or encrypted form using an algorithm or algorithms known by said software application, and said software application will deobfuscate/decode and/or decrypt the Original Storage Media Identification using said algorithm so that the stated comparison procedure of claim 13 can compare the Current Storage Media Identification and the Original Storage Media Identification in a deobfuscated/decoded and/or decrypted form.

16. The computer implemented method of claim 13, wherein the storage media identification data or values contain, at least in some part, data or values that represent characteristics of the storage media; such as but not limited to storage media capacity, storage media manufacturer, or storage media type.
